(19) United States
(12) Patent Application Publication
(10) Pub. No.: US 2025/0176541 A1
(43) Pub. Date: Jun. 5, 2025

(54) COMPOSITIONS AND METHODS FOR LONG LASTING DISINFECTION WITH MIXED SOLVENT SYSTEMS

(71) Applicant: Specialty Operations France, Lyon (FR)

(72) Inventors: Amit SEHGAL, Potomac, MD (US); Thomas BROPHY, Philadelphia, PA (US)

(21) Appl. No.: 18/840,735

(22) PCT Filed: Mar. 2, 2023
(86) PCT No.: PCT/EP2023/055377

§ 371 Date: Aug. 22, 2024

Related U.S. Application Data
(60) Provisional application No. 63/316,373, filed on Mar. 3, 2022.

(51) Int. Cl. A01N 33/12; A01N 25/02; A01N 25/30; A01N 31/02; A01P 1/00

(52) U.S. Cl. CPC A01N 33/12; A01N 25/02; A01N 25/30; A01N 31/02; A01P 1/00

(57) ABSTRACT

An antimicrobial composition that includes: an antimicrobial component having at least one quaternary ammonium compound; a synthetic polymer that includes: at least one cationic monomer A_{b}, optionally, at least one anionic monomer Ba, and optionally, at least one non-ionic monomer Cₐ; an organic acid; at least 20 wt. % of an organic polar solvent, preferably at least 30 wt. % of an organic polar solvent, based on a total weight of the composition; and a surfactant selected from cationic surfactants, amphoteric surfactants and combinations thereof, wherein the composition is free of non-ionic surfactants and the composition has a pH of at least 7. This composition when applied to a surface provides a combination of “quick-kill” efficacy and robust long lasting disinfection.

### BACKGROUND

It is often desirable to provide biocidal protection for materials on which harmful microorganisms can typically survive for a given period of time. In this respect, the importance of providing long lasting disinfection to material surfaces has only increased. Most materials do not naturally have surfaces that prevent microbial contamination without applying an antimicrobial product to the surface of the material. As such, one useful way to improve the microorganism resistance of a surface is to treat the surface with a formulation that provides a biocidal effect and also prevents future growth until the next application.

One common method of treating a surface is to apply a layer of a liquid formulation to that surface and then dry the layer or allow the layer to dry. It is desirable that such liquid formulations are clear and stable, and remain stable during storage. It is also desirable that such liquid formulations spread evenly when applied to a surface, including hard, flat surfaces. It is desirable that such films, when dry, have one or more of the following desirable properties: clarity, non-tackiness; durability to repeated touching or wiping; no long term build-up; and the ability to maintain biocidal efficacy under normal use for an extended period of time after application to a surface.

Typical commercial antimicrobial compositions that are available as disinfectants, or as cleaners with disinfecting activity, generally achieve microbial kill at 99.9% or greater, only within the short contact time as specified by the product use instructions. However, re-soiling or contamination of the surface requires additional treatments with such compositions. That is, typical commercial antimicrobial composition do not have long lasting disinfection, but rather demonstrate “quick-kill” efficacy (i.e., a high microbial kill in a relatively short period of time after application to the surface) without long lasting disinfection. A need, therefore, exists for antimicrobial formulations that provide high microbial kill without the need for repeated applications. In particular, a need still exists for antimicrobial formulations that provide high microbial kill and long lasting disinfection without the need for repeated applications within 12 hours, and preferably without the need for repeated applications within 24 hours. However, designing compositions that meet the above requirements is a difficult task in view of unpredictable and complicated interactions between ingredients, including the interaction between the solvents and other compounds in the compositions. In fact, forming a resilient film on the surface of material that can provide long lasting disinfection requires the solvents to not interfere with or prevent the formation of the film on the surface of materials, or otherwise reduce or compromise the formation and wear resistance of the film.

With respect to typical commercial antimicrobial compositions for disinfecting hard surfaces, the use of organic polar solvents in the same is well known since the organic polar solvents enable a wide range of attributes not achievable by using only water as the sole solvent. Some common attributes achieved by using organic polar solvents in hard surface compositions can include, but are not limited to: enhancing the solubility of certain ingredients in the composition; improving cleaning performance against greasy or other soils; reducing foam generation during product application or cleaning; and aiding in antimicrobial efficacy. With respect to antimicrobial efficacy, certain organic polar solvents are widely used in sanitizing or disinfecting hard surface compositions, or hard surface compositions that have both sanitizing and disinfecting properties, either alone or in combination with other compounds and ingredients known to be useful for the same. However, these compositions are generally limited to “quick-kill” compositions. That is, while certain organic polar solvents are widely used in “quick kill” compositions, such organic polar solvents have not be used for compositions that maintain long lasting disinfection and residual antimicrobial efficacy for extended periods of time given that such organic solvents can interfere with or prevent the formation of the film on the surface of materials, or otherwise can reduce or compromise the formation of the film. For example, the physical properties of the organic polar solvent can affect the long lasting antimicrobial efficacy of the composition insomuch that organic polar solvents exhibiting undesirable solubility, evaporation rate, and/or vapor pressure can prevent the formation of a dry layer or film on the treated surface, which can result in a poorly durable layer or film without long lasting residual antimicrobial efficacy.

Further, antimicrobial compositions having higher amounts of organic polar solvents can exhibit turbidity and phase instability. That is, when the organic polar solvent is above a certain amount (e.g., about 20 wt. % or more, preferably about 30 wt. % or more, based on the total weight of the composition), the organic polar solvent can be unstable in the composition. This can lead to the formation of more than one phase in the composition (i.e., forming a non-homogenous composition), such as forming two separate layers or phases in the compositions, which can impact the overall stability of the composition. In addition to impacting the overall stability of the composition, turbidity or phase instability of the organic polar solvent(s) can impact the ability of the composition to properly form a layer or film on a surface. This is due to the composition being in separate phases and not forming a homogenous film on the surface of a material. In this respect, any inability for the composition to form a proper layer or film on the surface of a material may impact the ability of the composition to provide both “quick-kill” and long lasting antimicrobial efficacy. Given the turbidity and phase instability challenges, as well as the other challenges discussed above, there remains a need in the art for antimicrobial compositions that have an organic polar solvent or solvents, including relatively high amounts of such organic polar solvent(s), that provide both “quick-kill” and long lasting antimicrobial efficacy.

In order to overcome these problems, the compatibility (or phase stability) of the organic polar solvent can be adjusted such that the charge balance of the organic polar solvent(s) and other ingredients is stable. Additionally, the pH of the composition can be adjusted so that the phase stability of the organic polar solvent in the composition is improved. This likewise can also improve the turbidity and transparency of the composition.

Accordingly, incorporating and stabilizing an organic polar solvent into long lasting antimicrobial compositions is beneficial by providing such compositions with a combination of the benefits attributed to the organic polar solvent, as discussed above which includes providing the “quick-kill” antimicrobial benefits associated with such solvents, while also providing compositions with long lasting antimicrobial efficacy. Moreover, this can be highly beneficial in providing compositions that demonstrate both “quick-kill” and long lasting antimicrobial efficacy, which can be adapted to different applications and uses, such as aerosol sprays, trigger sprays, pressure sprays, pump sprays, wipes, including disposable pre-wet wipes, and similar applications and uses. Likewise, in addition to the “quick-kill” and long lasting antimicrobial efficacy, the compositions can also have other beneficial properties, such as sufficient degreasing, cleaning, and foaming properties, along with desirable aesthetics, all while maintaining sufficient antimicrobial efficacy.

### BRIEF DESCRIPTION OF THE DRAWINGS

FIG. 1 depicts the turbidity of various compositions having different concentrations of ethanol as the organic polar solvent.

### SUMMARY

The present disclosure generally relates to hard surface treatment compositions comprising: an antimicrobial component comprising at least one quaternary ammonium compound; a synthetic polymer comprising: at least one cationic monomer A_{b}, optionally, at least one anionic monomer Bₐ, and optionally, at least one non-ionic monomer Cₐ; an organic acid; at least 20 wt. % of an organic polar solvent, preferably at least 30 wt. % of an organic polar solvent, based on a total weight of the composition; and a surfactant selected from the group consisting of cationic surfactants, amphoteric surfactants and combinations thereof, wherein the composition is free of non-ionic surfactants and the composition has a pH of at least 7. In particular, the present disclosure relates to hard surface treatment compositions comprising: an antimicrobial component comprising at least one quaternary ammonium compound; a synthetic polymer comprising: at least one cationic monomer A_{b}, optionally, at least one anionic monomer Bₐ, and optionally, at least one non-ionic monomer Cₐ; an organic acid; at least 20 wt. % of an organic polar solvent, preferably at least 30 wt. % of an organic polar solvent, based on a total weight of the composition; and a surfactant selected from the group consisting of cationic surfactants, amphoteric surfactants and combinations thereof, wherein the composition is free of non-ionic surfactants and the composition has a pH of at least 7, in which the compositions have long lasting antimicrobial efficacy, and more specifically a film formed from the composition kills at least 95% of microorganisms for at least 3 wet abrasion cycles and 3 dry abrasion cycles, with 2 abrasions per cycle according to RSS-12 h. The present disclosure also relates to hard surface treatment compositions comprising: an antimicrobial component comprising at least one quaternary ammonium compound; a synthetic polymer comprising: at least one cationic monomer A_{b}, optionally, at least one anionic monomer Bₐ, and optionally, at least one non-ionic monomer Cₐ, an organic acid; at least 20 wt. % of an organic polar solvent, preferably at least 30 wt. % of an organic polar solvent, based on a total weight of the composition; and a surfactant selected from the group consisting of cationic surfactants, amphoteric surfactants and combinations thereof, wherein the composition is free of non-ionic surfactants and the composition has a pH of at least 7, in which the compositions have long lasting antimicrobial efficacy, and more specifically a film formed from the composition kills at least 95% of microorganisms for at least 6 wet abrasion cycles and at least 6 dry abrasion cycles, with 2 abrasions per cycle according to RSS, as well as such compositions having long lasting antimicrobial efficacy in which a film formed from the composition kills at least 95% of microorganisms for at least 6 wet abrasion cycles and at least 6 dry abrasion cycles, with 4 abrasions per cycle according to RSD.

The present disclosure further relates to such hard surface treatment compositions in which a film formed from the composition kills at least 95% of gram-positive bacteria and gram-negative bacteria, or enveloped and non-enveloped viruses according to Environmental Protection Agency (EPA) Protocol #01-1A residual self-sanitizing activity test. Moreover, the present disclosure relates to a method of stabilizing organic polar solvents in long lasting antimicrobial compositions. Also presented are methods of providing a surface with residual antimicrobial action that include the step of applying a composition of the present disclosure to the surface. The present disclosure also provides a substrate with residual antimicrobial action comprising a substrate wherein at least a portion of the substrate is coated with a composition of the present disclosure.

### DETAILED DESCRIPTION

The present disclosure relates to long lasting antimicrobial compositions, containing at least one polar organic solvent, that is partially or wholly miscible with water and are free of non-ionic surfactants, including methods of their application to treated surfaces. The present compositions achieve microorganism (e.g. bacterial, viral, or fungal) kill of at least 95% or greater, (e.g. 99.9% kill), for 12 to 24 hours obviating the need for repeated treatment. The present compositions also enable faster kill of certain microorganisms, such as bacterial, viral, fungal, or combinations thereof, as substantiated by tests according to the Association of Official Analytical Collaboration (AOAC) Use Dilution Test (UDT) for Testing Disinfectants (MB-05-16) or the Disinfecting Towelette test EPA MB-09-07 for the use of wipes as the application medium. Tests of this nature may generally be referred to as “quick-kill” antimicrobial efficacy tests.

In order to substantiate 24 hour long-term sanitization claims with the United States Environmental Protection Agency (EPA), compositions are evaluated with the residual self-sanitization (RSS) method, EPA Protocol #01-1A (https://www.epa.gov/sites/production/files/2015-09/documents/cloroxpcol_final.pdf). For validating longer term disinfection, all extant test protocols emulate the maximum amount of recontamination and abrasion by touching and wiping anticipated before reapplication, typically a 24 hour period. An intermediate protocol with approximately half the level abrasion and re-soiling challenge to a surface is presented here as the “RSS-12 h” test protocol.

In light of the COVID-19 pandemic, the EPA issued new guidance to assess products for “long-lasting” or “residual” effectiveness on surfaces against viruses such as SARS-COV-2. Specific testing modifications to the residual self-sanitizing (RSS) activity test, (EPA Protocol #01-1A) disclosed herein, were provided by the EPA in support of the new claim as detailed in (https://www.epa.gov/pesticide-registration/interim-guidance-review-products-adding-residual-efficacy-claims), presented here as the “RSD” test protocol, which stands for Residual Self-Disinfection. For residual bactericidal disinfectant claims under the RSD test protocol, products need to achieve greater than or equal to 5 log (99.999%) reduction of the base bacteria (Staphylococcus aureus and Pseudomonas aeruginosa), within an allowable contact time, when compared to the parallel abrasion and re-inoculation controls. The RSD test protocol has double the abrasions (4 abrasions per cycle, 6 dry and 6 wet cycles) and at least 11 re-inoculations when compared to the RSS. With RSD being a pre-requisite with Pseudomonas aeruginosa and Staphylococcus aureus for residual virucidal claims, products need to achieve greater than or equal to 3 log (99.9%) reduction of the most difficult to kill virus claimed by the product, within the allowable contact time, when compared to the parallel abrasion and re-inoculation controls.

Due to the time consuming nature of the EPA residual self-sanitizing (RSS) activity test (EPA Protocol #01-1A) and RSS-12 h test, as well as the inherently limited number of products that can be tested in a single experiment, it is often desirable to identify and employ the use of “screening” experiments before conducting even an RSS-12 h test, or especially the full EPA RSS Protocol #01-1A. In this case, a “screening” experiment generally refers to a modified version of a given “full” test methodology (e.g. EPA Protocol #01-1A), such that the “screening” test can: be conducted in an overall shorter amount of time, evaluate more samples per experiment, and produce results considered illustrative or predictive of those that would be obtained by the “full” test methodology. Described herein is an “RSS-Screening” test, which is a modified version of the EPA residual self-sanitizing (RSS) activity test (EPA Protocol #01-1A).

The RSS-Screening test allows for higher throughput testing of long lasting residual disinfectant candidates prior to conducting EPA Protocol #01-1A, and shows agreement with the “full” RSS. That is, it has been demonstrated that embodiments which fail the RSS-Screening also fail when tested according to EPA Protocol #01-1A. Likewise, it has been demonstrated that embodiments which pass the RSS-Screening also pass when tested according to EPA Protocol #01-1A. It is therefore beneficial to utilize the RSS-Screening to determine if developmental disinfectant compositions possess long lasting or residual efficacy as substantiated by EPA Protocol #01-1A.

In an embodiment, a film formed from the composition kills at least 99.9% (e.g. log 3 reduction) of microorganisms according to the residual self-sanitizing (RSS) activity test (EPA Protocol #01-1A). In another embodiment, a film formed from the composition kills at least 99.9% (e.g. log 3 reduction) of microorganisms according to the RSS-Screening test. In yet another embodiment, a film formed from the composition kills at least 99.999% (e.g. log 5 reduction) of microorganisms according to the RSD test. And in preferred embodiments, a film formed from the composition kills at least 99.9% (e.g. log 3 reduction) of microorganisms according to the residual self-disinfection (RSD) test, residual self-sanitizing (RSS) activity test (EPA Protocol #01-1A) and the RSS-Screening test.

In another embodiment, a film formed from the composition kills at least 99.9% (e.g. log 3 reduction) of gram-negative bacteria according to the RSS-Screening test. In yet another embodiment, a film formed from the composition kills at least 99.999% (e.g. log 5 reduction) of gram-negative bacteria according to the RSD test. And in preferred embodiments, a film formed from the composition kills at least 99.9% (e.g. log 3 reduction) of gram-negative bacteria according to all the residual self-disinfection (RSD) test, residual self-sanitizing (RSS) activity test (EPA Protocol #01-1A) and the RSS-Screening test.

In further embodiments, a film formed from the composition kills at least 99.9% (e.g. log 3 reduction) of gram-positive bacteria, gram-negative bacteria, or both gram-positive and gram-negative bacteria according to the residual self-sanitizing (RSS) activity test (EPA Protocol #01-1A). In another embodiment, a film formed from the composition kills at least 99.9% (e.g. log 3 reduction) of gram-positive bacteria, gram-negative bacteria, or both gram-positive and gram-negative bacteria according to the RSS-Screening test. And in preferred embodiments, a film formed from the composition kills at least 99.9% (e.g. log 3 reduction) of gram-positive bacteria, gram-negative bacteria, or both gram-positive and gram-negative bacteria according to both the residual self-sanitizing (RSS) activity test (EPA Protocol #01-1A) and the RSS-Screening test.

Products having long lasting disinfection or sanitization claims, or products having both disinfection and sanitization claims are substantiated by the RSS test, which challenges the applied composition by subjecting it to recontamination (re-inoculation with microorganisms) and abrasion (wear cycles). An intermediate test protocol, with approximately half the number of re-inoculations and wear cycles (“RSS-12 h”) is used to predict disinfection that is durable up to 12 hours before reapplication of the test product. This procedure, as in the full RSS test, requires preparation of the test bacterial (microbial) culture over the first week (see EPA Protocol #01-1A) followed by testing in week 2.

As with the RSS test, the RSS-12 h testing involves inoculating the surface with bacteria, followed by application of the product on the substrate and allowing it to dry. The substrate may be glass, polycarbonate, or steel. This substrate is then subjected to an abrasion-re-inoculation regime of 3 “wear cycles”. The abrasion is conducted with a 1084 g wt. rectangular steel block covered with a cloth with an underlying thin polyurethane-foam layer. Each wear cycle is composed of a “dry” abrasion and a “wet” abrasion, the latter with the cloth cover having been wet with a mist of water using a Preval® sprayer. Each abrasion (dry/wet) is characterized by a back and forth motion of the block across the test substrate. Each abrasion cycle is followed by re-inoculation the surface with a bacterial culture. The RSS-12 h involves a 3-abrasion cycle/3-inoculations test as compared to the full RSS test that outlines a 6-abrasion cycle/6-inoculation test regimen. All other details of the test method are as outlined in the EPA Protocol #01-1A. The RSS-Screening does not incorporate re-inoculation in between wear cycles. The test involves 6-abrasion cycles all of which are “wet”. That is, all “dry” wears are substituted with “wet” consecutive wears in order to further stress the durability of the dried film.

The test substrate is allowed to dry and then finally inoculated again (sanitizer test) for 5 minutes, followed by neutralization of the entire substrate. Surviving bacteria is then harvested off the surface and cultured with serial dilutions on agar plates, allowing colony formation over 24-48 hours. Surviving bacteria are then counted as the number of colonies. The difference in bacterial count inoculated and surviving bacteria results in an efficacy evaluation in percent kill (e.g. 99.9% kill) or log-reduction (e.g. 3-log reduction) on a logarithmic scale. The bacteria in this test may be substituted for other microorganisms such as fungi or viruses. In an embodiment, microorganisms are selected from gram-positive bacteria (e.g Staphylococcus aureus), gram-negative bacteria (e.g. Pseudomonas aeruginosa) fungi, enveloped viruses, non-enveloped viruses, and combinations thereof.

The composition of the present disclosure is a liquid formulation. It is contemplated that one preferred method of making use of the composition of the present disclosure is to apply a layer of the composition to a substrate and dry the composition or allow it to dry. The act of applying a layer of the composition to a substrate and then drying it or allowing it to dry is known herein as “treating” the substrate. It is contemplated that, as the solvent or combination of solvent(s) evaporate, the composition will form a film on the substrate. For this reason, selection of preferred organic polar solvent(s) can take into consideration each individual solvent's volatility, as well as the volatility of the overall mixture, based on the vapor pressure of each solvent and, if applicable the vapor pressure of the mixture. That is, in preferred embodiments, the selected organic polar solvent(s) can easily evaporate to form a dried layer or film without interfering with or preventing the formation of the dried layer or film on the surface of materials, or otherwise reduce or compromise the formation of the dried layer or film. As used herein, the term “dried layer” of the composition is synonymous with “a film”.

In an embodiment, the composition includes: an antimicrobial component that includes at least one quaternary ammonium compound; a synthetic polymer that includes: at least one cationic monomer A_{b}, optionally, at least one anionic monomer Bₐ, and optionally, at least one non-ionic monomer Cₐ; an organic acid; at least one organic polar solvent, preferably at least 20 wt. % and more preferably at least 30 wt. % of the organic polar solvent based on a total weight of the composition (which can act as a carrier solvent); and a surfactant selected from cationic surfactants, amphoteric surfactants and combinations thereof, wherein the composition is free of non-ionic surfactants. In certain embodiments, the compositions can have at least 20 wt. % to 65 wt. %, including at least 30 wt. % to 65 wt. %, preferably at least 35 wt. % to 60 wt. %, of the organic polar solvent, based on a total weight of the composition. And in certain preferred embodiments, the compositions can have the aforementioned amounts of the organic polar solvent in combination with a pH ranging from about 6 to 10, including about 7 to 10, preferably about 7 to about 9, even more preferably about 7 to about 8, as well as from about 7.5 to about 8.5.

As used herein, the terms “free of non-ionic surfactants” and “non-ionic surfactant free” refer to a composition, mixture, or ingredients that do not contain non-ionic surfactants, for example, non-ionic alkyl glycol ethers, alkoxylated fatty alcohols, alkoxylated oxoalcohols, alkoxylated fatty acid alkyl esters, alkoxylated fatty acid amides, polyhydroxy fatty acid amides, alkyl phenol polyglycol ethers, alkyl (poly)glucosides or to which the same has not been added.

In some embodiments, the pH of the composition can range from about 0.5 to about 10, preferably from about 0.5 to about 7, more preferably about 0.5 to about 5. In another embodiment, the pH of the composition can be less than 7, preferably less than 6, and more preferably less than 5. In another embodiment, the pH of the composition can range from 2 to 4.9. In yet another embodiment, the pH of the composition can range from 3 to 4.8. In an embodiment, the pH of the composition can range from 0.5 to 3. In a separate embodiment, the pH of the composition can range from about 7 to 10, and preferably about 7 to about 9, and even more preferably about 7 to about 8. In another embodiment, the pH of the composition can range from about 7.5 to about 8.5.

The antimicrobial compositions of the present disclosure include at least one quaternary ammonium compound. In an embodiment, the quaternary ammonium compound is an antimicrobial “quat.” The term “quaternary ammonium compound” or “quat” generally refers to any composition with the following formula:

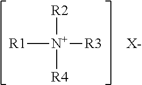

where R1-R4 are alkyl groups that may be alike or different, substituted or unsubstituted, saturated or unsaturated, branched or unbranched, and cyclic or acyclic and may contain ether, ester, or amide linkages; they may be aromatic or substituted aromatic groups. In an embodiment, groups R1, R2, R3, and R4 each have less than a C20 chain length. X⁻ is an anionic counterion. The term “anionic counterion” includes any ion that can form a salt with quaternary ammonium. Examples of suitable counterions include halides such as chlorides, bromides, fluorides, and iodides, sulphonates, propionates, methosulphates, saccharinates, ethosulphates, hydroxides, acetates, phosphates, carbonates, bicarbonates, and nitrates. In an embodiment, the anionic counterion is chloride.

In some embodiments, quaternary ammoniums having carbon chains of less than 20 or C2-C20 are included in compositions of the present disclosure. In other embodiments, quaternary ammoniums having carbon chains of C6-C18, C12-C18, C12-C16 and C6-C10 are included in compositions of the present disclosure. Examples of quaternary ammonium compounds useful in the present disclosure include, but are not limited to, alkyl dimethyl benzyl ammonium chloride, alkyl dimethyl ethylbenzyl ammonium chloride, octyl decyl dimethyl ammonium chloride, dioctyl dimethyl ammonium chloride, and didecyl dimethyl ammonium chloride. A single quaternary ammonium or a combination of more than one quaternary ammonium may be included in compositions of the present disclosure. Further examples of quaternary ammonium compounds useful in the present disclosure include, but are not limited to, benzethonium chloride, ethylbenzyl alkonium chloride, ethyl benzethonium chloride, myristyl trimethyl ammonium chloride, methyl benzethonium chloride, cetalkonium chloride, cetrimonium bromide (CTAB), carnitine, dofanium chloride, tetraethyl ammonium bromide (TEAB), domiphen bromide, benzododecinium bromide, benzoxonium chloride, choline, denatonium, and mixtures thereof.

In some embodiments depending on the nature of the R group, the anion, and the number of quaternary nitrogen atoms present, the antimicrobial quaternary ammonium compounds may be classified into one of the following categories: monoalkyltrimethyl ammonium salts; monoalkyldimethylbenzyl ammonium salts; dialkyldimethyl ammonium salts; heteroaromatic ammonium salts; polysubstituted quaternary ammonium salts; bis-quaternary ammonium salts; and polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercial available under the trade names Rhodaquat® M242C/29 and Dehyquart® A; alkyltrimethyl ammonium chloride, commercially available as Arquad® 16; alkylaryltrimethyl ammonium chloride; and cetyldimethyl ethylammonium bromide, commercially available as Ammonyx® DME.

Monoalkyldimethylbenzyl ammonium salts contain one R group that is a long-chain alkyl group, a second R group that is a benzyl radical, and the two remaining R groups are short-chain alkyl groups, such as methyl or ethyl groups. Some non-limiting examples of monoalkyldimethylbenzyl ammonium salts include alkyldimethylbenzyl ammonium chlorides, commercially available as Barquat® from Lonza Inc.; and benzethonium chloride, commercially available as Lonzagard®, from Lonza Inc. Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC® 2125M from Stepan Company, and Barquat® 4250 from Lonza Inc. Other examples include N,N-benzyldimethyloctylammonium chloride, N,N-benzyldimethyldecylammonium chloride, N-dodecyl-N-benzyl-N,N-dimethylammonium chloride, N-tetradecyl-N-benzyl-N,N-dimethylammonium chloride, N-hexadecyl-N,N-dimethyl-N-benzylammonium chloride, N,N-dimethyl N-benzyl N-octadecyl ammonium chloride.

Dialkyldimethyl ammonium salts contain two R groups that are long-chain alkyl groups, and the remaining R groups are short-chain alkyl groups, such as methyl groups. Some non-limiting examples of dialkyldimethyl ammonium salts include didecyldimethyl ammonium halides, commercially available as Bardac® 22 from Lonza Inc.; didecyl dimethyl ammonium chloride commercially available as Bardac® 2250 from Lonza Inc.; dioctyl dimethyl ammonium chloride, commercially available as Bardac® LF and Bardac® LF-80 from Lonza Inc.; and octyl decyl dimethyl ammonium chloride sold as a mixture with didecyl and dioctyl dimethyl ammonium chlorides, commercially available as Bardac® 2050 and 2080 from Lonza Inc.

Heteroaromatic ammonium salts contain one R group that is a long-chain alkyl group, and the remaining R groups are provided by some aromatic system. Accordingly, the quaternary nitrogen to which the R groups are attached is part of an aromatic system such as pyridine, quinoline, or isoquinoline. Some non-limiting examples of heteroaromatic ammonium salts include cetylpyridinium halide, commercially available as Sumquat® 6060/CPC from Zeeland Chemical Inc.; 1-[3-chloroalkyl]-3,5,7-triaza-1-azoniaadamantane, commercially available as Dowicil® 200 from The Dow Chemical Company; and alkyl-isoquinolinium bromide.

Polysubstituted quaternary ammonium salts are a monoalkyltrimethyl ammonium salt, monoalkyldimethylbenzyl ammonium salt, dialkyldimethyl ammonium salt, or heteroaromatic ammonium salt wherein the anion portion of the molecule is a large, high-molecular weight (MW) organic ion. Some non-limiting examples of polysubstituted quaternary ammonium salts include alkyldimethyl benzyl ammonium saccharinate, and dimethylethylbenzyl ammonium cyclohexylsulfamate.

Bis-quaternary ammonium salts contain two symmetric quaternary ammonium moieties having the general formula:

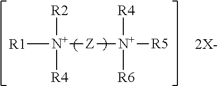

where the R groups may be long or short chain alkyl, a benzyl radical or provided by an aromatic system. Z is a carbon-hydrogen chain attached to each quaternary nitrogen. Some non-limiting examples of bis-quaternary ammonium salts include 1,10-bis(2-methyl-4-aminoquinolinium chloride)-decane; and 1,6-bis[1-methyl-3-(2,2,6-trimethyl cyclohexyl)-propyldimethylammonium chloride] hexane or triclobisonium chloride.

Alkoxysilyl quaternary ammonium compounds are also approved for use in antimicrobial compositions. These include but are not limited to trimethoxysilyl quaternary ammonium chlorides such as 3-(trimethoxysilyl) propyl dimethyl octadecyl ammonium chloride. Initially developed by Dow Corning, these are available as ORGANOSILANE, SIQUATS, SIQAC's, and SILQUATS among others.

In an embodiment, the quaternary ammonium compound is a medium to long chain alkyl R group, such as from 8 carbons to about 20 carbons, from 8 carbons to about 18 carbons, from about 10 to about 18 carbons, and from about 12 to about 16 carbons, and providing a soluble and good antimicrobial agent.

In an embodiment, the quaternary ammonium compound is a short di-alkyl chain quaternary ammonium compound having an R group, such as from 2 carbons to about 12 carbons, from 3 carbons to about 12 carbons, or from 6 carbons to about 12 carbons.

The composition may include from about 100 to about 100,000 ppm of one or more quaternary ammonium compounds. In various embodiments, the composition includes from about 500 to about 50,000 ppm; from about 500 to about 10,000 ppm; or from about 500 to about 5000 ppm of one or more quaternary ammonium compounds.

Polymers suitable for use in compositions of the present disclosure include synthetic polymers having: at least one cationic monomer A_{b}, optionally, at least one anionic monomer Bₐ, and optionally, at least one non-ionic monomer Cₐ. In one embodiment, the synthetic polymer includes its homopolymer, copolymer, terpolymer, block copolymer, random polymer, linear polymer, comb polymer or branched polymer.

Any combination of these types of monomers may be used. For example, suitable polymers include but are not limited to those comprising, consisting of or consisting essentially of at least one monomer of type A_{b} and at least one monomer of type Bₐ and polymers comprising, consisting of or consisting essentially of at least one monomer of type A_{b} and at least one momoner of type Cₐ, and polymers comprising, consisting of or consisting essentially of at least one of each of the three types of monomer.

In an embodiment the cationic monomer A_{b} includes an ammonium group of formula —NR3+, wherein R, which is identical or different, represents a hydrogen atom, an alkyl group comprising 1 to 10 carbon atoms, or a benzyl group, optionally carrying a hydroxyl group, and comprise an anion (counter-ion). Examples of anionic counter-ions are halides such as chloride and bromides, sulphates, hydrosulphates, alkylsulphates (for example comprising 1 to 6 carbon atoms), sulfonates, phosphates, nitrates, citrates, formates, and acetates.

Examples of cationic monomer A_{b} include, but are not limited to:

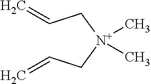

Diallyldimethylammonium halides such as diallyldimethylammonium chloride (DADMAC) or the corresponding bromide. Alternatively, the counter ion may be sulphate, nitrate or phosphate. Similar momomer units, such as those in which one or more of the CH₃ groups is replaced by a C_{2 to 12} for example a C_{2 to 6} alkyl group or one or more of the CH₂ groups is replaced by an alkyl group having from 2 to 12, for example from 2 to 6 carbon atoms may be used. In other words, other similar commercially available monomers or polymers containing such monomers may be used.

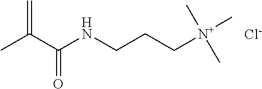

N,N,N-trimethyl-3-((2-methyl-1-oxo-2-propenyl)amino)-1-propanaminium halides, such as the chloride (MAPTAC, also known as methacryl-amido (propyl)-trimethyl ammonium chloride).

Additional examples of cationic monomer A_{b} include, but are not limited to:
1. aminoalkyl (meth)acrylates, aminoalkyl (meth)acrylamides,
2. monomers, including particularly (meth)acrylates, and (meth)acrylamides derivatives, comprising at least one secondary, tertiary or quaternary amine function, or a heterocyclic group containing a nitrogen atom, vinylamine or ethylenimine;
3. diallyldialkyl ammonium salts;
4. their mixtures, their salts, and macromonomers deriving from therefrom;
5. dimethylaminoethyl (meth)acrylate, dimethylaminopropyl ditertiobutylaminoethyl (meth)acrylate, dimethylaminomethyl (meth)acrylate, (meth)acrylamide, dimethylaminopropyl (meth)acrylamide;
6. ethylenimine, vinylamine, 2-vinylpyridine, 4-vinylpyridine;
7. trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,
8. diallyldimethyl ammonium chloride,
9. monomers having the following formula A(II):

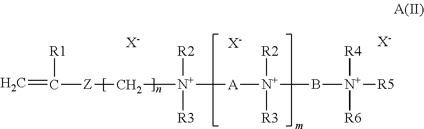

wherein R₁ is a hydrogen atom or a methyl or ethyl group; R₂, R₃, R₄, R₅ and R₆, which are identical or different, are linear or branched C₁-C₆, preferably C₁-C₄, alkyl, hydroxyalkyl or aminoalkyl groups; m is an integer from 0 to 10, for example 1; n is an integer from 1 to 6, preferably 2 to 4; Z represents a —C(O)O— or —C(O)NH— group or an oxygen atom; A represents a (CH₂)ₚ group, p being an integer from 1 to 6, preferably from 2 to 4; B represents a linear or branched C₂-C₁₂, typically C₃-C₆, polymethylene chain optionally interrupted by one or more heteroatoms or heterogroups, in particular O or NH, and optionally substituted by one or more hydroxyl or amino groups, preferably hydroxyl groups; X, which are identical or different, represent counterions, and their mixtures, and macromonomers deriving therefrom.

Other cationic monomers include compounds of general formula A(I):

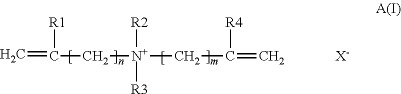

in which: R₁ and R₄, independently of each other, represent a hydrogen atom or a linear or branched C₁-C₆ alkyl group; R₂ and R₃, independently of each other, represent an alkyl, hydroxyalkyl or aminoalkyl group in which the alkyl group is a linear or branched C₁-C₆ chain, preferably a methyl group; n and m are integers between 1 and 3; X, which may be identical or different, represent counterions which are compatible with the water-soluble or water-dispersible nature of the polymer. In one embodiment, X is selected from the group of halide anions, sulfate anions, hydrogen sulfate anions, phosphate anions, nitrate anions, citrate anions, formate anions, or acetate anions.

The polymers used in the present invention may have a polyampholyte structure such that the charge and surface adsorption are determined by pH. In an embodiment, the polymer is an acrylic acid amine-functional polymer. Examples of suitable hydrophilic polymers are described in U.S. Pat. Nos. 6,569,261, 6,593,288, 6,703,358 and 6,767,410, the disclosure of these documents is incorporated herein by reference. These documents describe water-soluble or water-dispersible copolymers including, in the form of polymerized units, (1) at least one amine-functional monomer, (2) at least one hydrophilic monomer with an acidic nature and (3) optionally at least one neutral hydrophilic monomer having an ethylenic unsaturation. The copolymers include quaternized ammonium acrylamide acid copolymers.

Examples of the anionic monomer Bₐ include, but are not limited to, acrylic acid, methacrylic acid, α-ethacrylic acid, β,β-dimethacrylic acid, methylenemalonic acid, vinylacetic acid, allylacetic acid, ethylideneacetic acid, propylideneacetic acid, crotonic acid, maleic acid, fumaric acid, itaconic acid, citraconic acid, mesaconic acid, N-methacryloylalanine, N-acryloylhydroxyglycine, sulfopropyl acrylate, sulfoethyl acrylate, sulfoethyl methacrylate, sulfoethyl methacrylate, styrenesulfonic acid, vinylsulfonic acid, vinylphosphonic acid, phosphoethyl acrylate, phosphonoethyl acrylate, phosphopropyl acrylate, phosphonopropyl acrylate, phosphoethyl methacrylate, phosphonoethyl methacrylate, phosphopropyl methacrylate and phosphonopropyl methacrylate, and the ammonium and alkali metal salts of these acids.

Examples of the non-ionic monomer Cₐ include, but are not limited to,

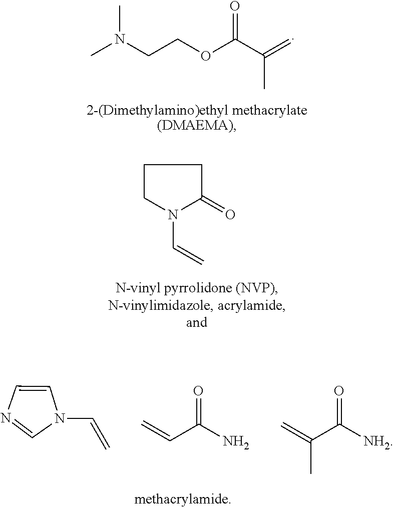

An example of a polymer suitable for use in the composition of the present disclosure is a polymer comprising, consisting of or consisting essentially of DMAEMA, MAPTAC and methylacrylic acid.

Suitable polymers include those sold under the trade name Mirapol®, for example as Mirapol® Surf-SHO, Mirapol® Surf-S110, Mirapol® Surf-S200 or Mirapol® Surf-S500 available from Solvay, Novecare.

Other suitable polymers include polymers comprising, consisting of or consisting essentially of DADMAC and acrylamide, such as those sold under the trade name Polyquat® 7 or PQ7 from Surfacare or under the trade name Merquat® S from Lubrizol. Other suitable polymers include polymers comprising, consisting of or consisting essentially of DADMAC and methacrylamide and/or, acrylic acid or methacrylic acid.

Polymers comprising, consisting of or consisting essentially of MAPTAC and acrylamide or methacrylamide are also suitable for use in the composition of the present disclosure. Also suitable are polymers comprising, consisting of or consisting essentially of MAPTAC and vinyl pyrrolidone, such as Polyquat® 28. Suitable polymers include those sold under the trade names Polyquart® Pro. (which is polyquat 28 plus silicone) and Polyquart® Ampo 140 from BASF.

Other suitable polymers include polymers comprising, consisting of or consisting essentially of MAPTAC and acrylic acid or methacrylic acid, such as those sold under the trade name Polyquat® Ampho, such as Polyquat® Ampho 149.

Polymers comprising, consisting of or consisting essentially of DMAEMA and vinylpyrrolidone are suitable for use in the composition of the present disclosure. An example of such a polymer is sold under the name PQ11 by BRB International.

Other suitable polymers include polymers comprising, consisting of or consisting essentially of DMAEMA and acrylamide, such as the polymer sold under the trade name Polyquat® 5.

In an embodiment, the molecular weight of the polymer ranges from about 130,000 g/mol to about 2 million g/mol.

In an embodiment, the amount of polymer in the composition ranges from about 200 ppm to about 4,000 ppm.

Compositions of the present disclosure further include one or more organic acids. In an embodiment, the organic acid is selected from citric, malic, maleic, oxalic, glutaric, succinic, lactic, glycolic, fumaric, acetic, benzoic, propionic, sorbic, tartaric, formic and mixtures of one or more such organic acids. In another embodiment, the counterion acid may be polymeric acid, such as, for example, poly(acrylic acid) or other polycarboxylic acids (e.g. maleic anhydride, methacrylic acid, etc.) or homopolymers or copolymers (e.g. methyl methacrylate, butyl acrylate, etc.) thereof, such as those in the Rhodoline® series available from Solvay. The composition may include from 500 to 50,000 ppm of one or more organic acids.

Compositions of the present disclosure further include one or more multifunctional organic acids, commonly referred to as chelating or sequestering agents. This may be selected from a list, but not limited to: ethylenediamine tetracetic acid and salts thereof, N,N-Dicarboxymethyl glutamic acid and salts thereof, N,N-bis(carboxymethyl) and salts thereof, Diethylenetriamine pentaacetate and salts thereof, among others. The composition may include from 500 to 50,000 ppm of one or more multifunctional organic acids.

Compositions of the present disclosure further include one or more organic polar solvents. In certain embodiments, the organic polar solvent or solvents can be combined with water to obtain an aqueous mixed solvent system. In certain embodiments, the organic polar solvent is an aliphatic alcohol, preferably selected from C₁-C₆ aliphatic alcohols, and more preferably C₂-C₆ aliphatic alcohols. In other embodiments, the organic polar solvent is selected from methyl alcohol, ethyl alcohol, propyl alcohol, including isopropyl alcohol, butyl alcohol, and mixtures thereof. For clarity, all isomers of the C₁-C₆ aliphatic alcohols, preferably C₂-C₆ aliphatic alcohols, are included, including but not limited to all isomers of propyl alcohol, butyl alcohol, pentyl alcohol, and hexyl alcohol, as well as mixtures of any of the isomers.

In other embodiments, the organic polar solvent or solvents can include, but are not limited to, acetone, acetonitrile, acetic acid, dimethylformamide (DMF), dimethylsulfoxide (DMSO), ethylene glycol, diethylene glycol, dimethyl carbonate, pyridine, benzonitrile, cyclohexanone, chloroform, butyl acetate, ethyl acetate, tetrahydrofuran (THF), or combinations thereof. Preferred among these are organic polar solvents that are volatile at standard temperature and pressure (i.e. evaporate easily at room temperature), and exhibit a vapor pressure greater than approximately 20 hPa, preferably a vapor pressure greater than 40 hPa, when measured as a pure substance at 20° C. Preferred organic polar solvent can also be at least partially soluble in water. In other preferred embodiments, the organic polymer solvent can be miscible in water. In further embodiments, the organic polar solvent(s) can be selected from isopropanol, ethanol, or combinations thereof. Referenced herein, “ethanol” generally refers to a polar solvent mixture containing predominantly (i.e. greater than 50% wt.) ethyl alcohol, optionally combined with water and/or denaturants. In a particularly preferred embodiment, the organic polar solvent used to obtain a mixed solvent system can be ethanol. In addition to the amounts and ranges discussed above for the organic polar solvent, in other embodiments, the composition may include from 1 wt. % to 75 wt. % of the organic polar solvent, including from 5 wt. % to 50 wt. % of the organic polar solvent, based on a total weight of the composition.

In compositions of the present disclosure, the surfactant is selected from cationic surfactants, amphoteric surfactants and combinations thereof. Cationic surfactants are surfactants that dissolve in water to result in a net cationic charge. In an embodiment, when present, the cationic surfactant is selected from cationic amine oxides, cationic betaines, propionates, amphoacetates and combinations thereof. Amine oxides, propionates, amphoacetates and betaines are cationic in the acidic pH conditions of the present disclosure. In an embodiment, the propionate is selected from cationic C8-C22 propionates and salts thereof. In another embodiment, the cationic C8-C22 propionate is selected from alkyl ampho (di) propionate, alkyl aminopropionates, alkyl amphopropionates, salts thereof, and combinations thereof. In an embodiment the cationic amphoacetate is selected from amphoacetates according to the following formula:

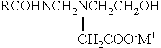

and diamphoacetates according to the following formula:

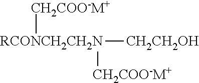

where R is an aliphatic group of 8 to 18 carbon atoms, and M is a cation such as sodium, potassium, ammonium, or substituted ammonium. Sodium lauroamphoacetate, sodium cocoamphoacetate, disodium lauroamphoacetate, and disodium cocoamphodiacetate are preferred in some embodiments.

In an embodiment, the betaine is selected from cationic C8-C22 betaines and salts thereof. In a further embodiment, the cationic C8-C22 betaine is selected from alkyl dimethylbetaines, alkylamidopropyl betaines, alkylampho(di)acetates, salts thereof, and combinations thereof. Where reference is made herein to “salts thereof” for cationic surfactants, these may be any suitable salts. In one embodiment the salt is a salt based on a monovalent cation, such as Na, K, or NH₄. In one embodiment, the salt is a salt based on an alkali metal, e.g. Na or K. The use of alternative salts, e.g. alkali earth metal salts such as Ca and Mg could also be contemplated; however the solubility of the product would need to be borne in mind when using such salts.

Amphoteric surfactants contain both a basic and an acidic hydrophilic group and an organic hydrophobic group. In an embodiment, when present, the amphoteric surfactant is selected from sultaines, taurates, and combinations thereof. In an embodiment, the composition includes a combination of one or more cationic and amphoteric surfactants.

In addition to the components described herein, the composition may also include water, fragrance, preservative, dye, corrosion inhibitor, builder, cleansing solvent, a strong base for pH adjustment, and other components known to be useful in antimicrobial compositions.

The compositions according to the present disclosure include both disinfectant cleaning compositions and concentrates which only differ in the relative proportion of water to that of the other constituents. In an embodiment, concentrated formulations include at least one quaternary ammonium compound in an amount ranging from about 800 ppm to about 100,000 ppm; or about 4,000 ppm to about 50,000 ppm; or about 10,000 ppm to about 50,000 ppm; a synthetic polymer in an amount ranging from about 800 ppm to about 50,000 ppm; or about 2,000 ppm to about 25,000 ppm; or about 4,000 ppm to about 20,000 ppm; an organic acid in an amount ranging from about 1,000 ppm to about 35,000 ppm; or about 5,000 ppm to about 25,000 ppm; or about 15,000 ppm to about 25,000 ppm; a surfactant selected from cationic surfactants, amphoteric surfactants and combinations thereof in an amount ranging from about 2,000 ppm to about 90,000 ppm; or about 10,000 ppm to about 75,000 ppm; or about 20,000 ppm to about 70,000 ppm, wherein the composition is free of non-ionic surfactants.

The concentrate can be used without dilution (concentrate:water 1:0) to extremely dilute dilutions (e.g., 1:10,000). In an embodiment, a range of dilution is from about 1:1 to about 1:1,000. In another embodiment, a range of dilution is from about 1:1 to about 1:500. In yet another embodiment, a range of dilution is from about 1:5 to about 1:256.

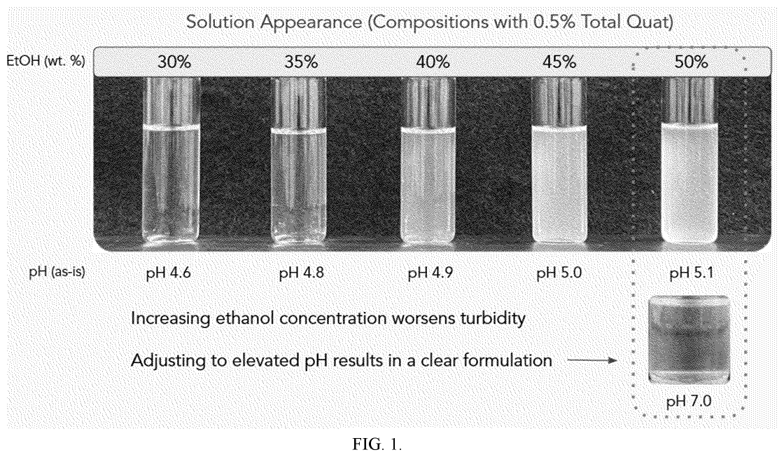

Also disclosed is a method of stabilizing high concentrations of the organic polar solvent, including C₁-C₆ aliphatic alcohols, and more preferably C₂-C₆ aliphatic alcohols, and even more preferably ethanol in the compositions. In this respect, it was unexpectedly found that compositions having relatively high amounts of the organic polar solvent demonstrate turbidity and phase stability issues. For example, in some embodiments adding ethanol from 5% up to 30% appeared clear and homogenous when formulating at low pH (<5); however, increasing the organic polar solvent (e.g. ethanol) content from 20 wt. % to 50 wt. % in increments of 5 wt. % (e.g. 20 wt. %, 35 wt. %, 40 wt. %, 45 wt. %, and 50 wt. %) showed turbidity and phase stability issues initially occurring at approximately 35 wt. % of ethanol. For instance, as shown in FIG. 1, when compositions have 0.5 wt. % of total quaternary ammonium compounds, as the amount of ethanol (EtOH) increases from 30% to 50%, the turbidity also increases. It is contemplated that the dramatic change in solvent character causes decreased solubility for certain components, leading to a turbid or even milky solution appearance. This turbidity is indicative of phase instability of the composition. Likewise, it was unexpectedly determined that adjusting the pH of the composition, such as increasing the pH from a low pH (or acidic pH) to a higher pH (neutral or alkaline) resolved the turbidity and phase stability issues. This is also shown in FIG. 1. In particular, as shown in FIG. 1, a composition having 0.5 wt. % of total quaternary ammonium compounds with 50 wt. % of ethanol at a pH of 5.1 has significant turbidity. However, when the pH is adjusted from 5.1 to a pH of 7.0, the turbidity is significantly reduced, which leads to a clear formulation.

In a particular embodiment, turbidity (phase instability) of the organic polar solvent can be reduced or removed by adjusting the pH, such as raising the pH, of the composition to a pH of at least 6, preferably to a pH of 7-10. In this respect, the composition can contain relatively high amounts (at least 20 wt. %, including at least 30 wt. %, preferably 20 wt. % to 65 wt. %, including at least 30 wt. % to 65 wt. %, and more preferably at least 35 wt. % to 60 wt. %, based on the total weight of the composition) of the organic polar solvent, such as ethanol. In a preferred embodiment, turbidity (phase instability) of the organic polar solvent can be reduced or removed by adjusting the pH, including raising the pH, of the composition to a pH 6-12. This includes even when the composition has high amounts of the organic polar solvent, (e.g., about 40 wt. % to about 50 wt. %, including about 45 wt. % to about 50 wt. %).

In certain embodiments, the pH of the composition can be adjusted by added conventional acids and bases as needed. In particular embodiments, since the compositions may already contain at least one acid, as discussed above, adding conventional bases, such as hydroxides of alkali metals, hydroxides of alkaline earth metals, or combinations thereof, to the compositions can adjust the pH by raising it to the desired level. In this respect, the conventional bases can include hydroxides of alkali metals, hydroxides of alkaline earth metals, or combinations thereof in the amount needed to adjust the pH to the desired level, including to the pH discussed above. Non-limiting examples of such bases include, but are not limited to, sodium hydroxide, potassium hydroxide, lithium hydroxide, magnesium hydroxide, calcium hydroxide, and mixtures thereof. Conventional bases can also include ammonia, ammonium hydroxide, and mixtures thereof.

In particular embodiments, the methods of stabilizing an organic polar solvent include adding a base to the compositions. In this respect, an embodiment includes stabilizing an organic polar solvent in a hard surface treatment composition, the hard surface treatment composition comprising:
a. an antimicrobial component comprising at least one quaternary ammonium compound;
b. a synthetic polymer comprising:
   i. at least one cationic monomer Ab,
   ii. optionally, at least one anionic monomer Ba, and
   iii. optionally, at least one non-ionic monomer Ca;
c. an organic acid;
d. at least 20 wt. % of an organic polar solvent, preferably at least 30 wt. % of an organic polar solvent, based on a total weight of the composition;
e. a surfactant selected from the group consisting of cationic surfactants, amphoteric surfactants and combinations thereof; and
f. at least one base, preferably at least one hydroxide of an alkali metal, hydroxide of an alkaline earth metal, or combinations thereof,
wherein the composition is free of non-ionic surfactants, and wherein the method comprises adding the at least one base to the hard surface treatment composition to adjust the pH of the hard surface treatment composition to at least 7, and preferably to a pH of about 7 to 10. In further embodiments, the base is selected from sodium hydroxide, potassium hydroxide, lithium hydroxide, magnesium hydroxide, calcium hydroxide, ammonia, ammonium hydroxide, and mixtures thereof.

This effect can be achieved for various concentrations of both the base composition (quaternary ammonium compound(s), synthetic polymer, surfactant(s), and organic acid(s)) along with ethanol, enabling formulation over a wider pH range with a higher tolerance for the organic polar solvent, such as ethanol. The invention described herein is desirable in that the same composition can be adapted to different applications and uses, such as but not limited to aerosol sprays, trigger sprays, pump sprays, pressure sprays, wipes, including disposable pre-wet wipes and similar applications and uses. Providing such compositions can be achieved by altering the organic polar solvent concentration, such as the ethanol concentration, raising the pH of the composition, or both.

Also disclosed are methods of providing a surface with residual antimicrobial action that includes the step of applying a composition of the present disclosure to the surface.

The composition may be applied to a surface by any method, including methods conducted by hand and methods conducted by machine and combinations thereof. For example, as noted above, the composition may be applied by spraying (pump, aerosol, pressure, etc.), pouring, spreading, metering (for example, with a rod or bar), mopping, wiping, brushing, dipping, mechanical application, other application methods, or combination thereof.

In an embodiment, compositions of the present disclosure can be used for aerosol or pressure spray applications. In this respect, relatively high levels of the organic polar solvent, such as ethanol (e.g., 20 wt. %-65 wt. %, preferably 35 wt. % to 60 wt. %, as well as about 40 wt. % to about 50 wt. %, including about 45 wt. % to about 50 wt. %) in the composition helps avoid foaming and other negative aesthetic characteristics whilst being expelled from a nozzle under pressure. Example propellants or pressurized substances used to spray the product via aerosol can or container may include, but are not limited to: volatile hydrocarbons (e.g. propane, n-butane, isobutane, isopentane, and mixtures thereof), hydrofluoroolefins (e.g. HFO-1234ze), pressurized carbon dioxide gas, pressurized nitrogen gas, pressurized nitrous oxide, and pressurized air.

In an embodiment, compositions of the present disclosure are also suited for use in a “spray and wipe” application. In such an application, the user generally applies an effective amount of the cleaning composition using the pump and within a few moments thereafter, wipes off the treated area with a rag, towel, or sponge, usually a disposable paper towel or sponge.

Compositions of the present disclosure, whether as described herein or in a concentrate or super concentrate form, can also be applied to a hard surface by using a wet wipe. The wipe can be of a woven or non-woven nature. Fabric substrates can include non-woven or woven pouches, sponges, in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former.

The non-woven fabrics may be a combination of wood pulp fibers and textile length synthetic fibers formed by well-known dry-form or wet-lay processes. Synthetic fibers such as rayon, nylon, orlon and polyester as well as blends thereof can be employed. The wood pulp fibers should comprise about 30 to about 60 percent by weight of the non-woven fabric, preferably about 55 to about 60 percent by weight, the remainder being synthetic fibers. The wood pulp fibers provide for absorbency, abrasion and soil retention whereas the synthetic fibers provide for substrate strength and resiliency.

The compositions of the present disclosure are absorbed onto the wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions.

Also provided are substrates with residual antimicrobial action that include a substrate wherein at least a portion of the substrate is coated with a composition of the present disclosure. The formulation of the present disclosure may be put to use by application any substrate. Some suitable substrates include, for example, countertops, mirrors, sinks, toilets, light switches, doorknobs, walls, floors, ceilings, partitions, railings, computer screens, keyboards, instruments, etc. Suitable substrates may be found in various settings including, for example, food preparation areas, households, industrial settings, architectural settings, medical settings, sinks, toilets, etc. Substrates may be made of any material; some suitable substrate compositions include, for example, plastic (including, for example, laminates and wall coverings), Formica, metal, glass, ceramic tile, paper (such as, for example, wallpaper), fabric, finished or unfinished wood, etc.

Also provided is the use of a composition of the present disclosure to substantially reduce or control the formation of microbial colonies on or at a surface. In an embodiment, a film formed from the composition kills at least 95% of microorganisms according to the RSS-Screening test. In another embodiment, a film formed from the composition kills at least 95% of microorganisms according to the residual self-sanitizing (RSS) activity test (EPA Protocol #01-1A). And yet in another embodiment, a film formed from the composition kills at least 95% of microorganisms according to the RSS-Screening test and residual self-sanitizing (RSS) activity test (EPA Protocol #01-1A). In another embodiment, the composition kills at provides full kill of microorganisms according to the Association of Official Analytical Collaboration (AOAC) Use Dilution Test (UDT) for Testing Disinfectants (MB-05-16).

In an embodiment, a film formed from the composition kills at least 95% of gram-negative bacteria according to the RSS-Screening test. In another embodiment, a film formed from the composition kills at least 95% of gram-negative bacteria according to the residual self-sanitizing (RSS) activity test (EPA Protocol #01-1A). And yet in another embodiment, a film formed from the composition kills at least 95% of gram-negative bacteria according to the RSS-Screening test and residual self-sanitizing (RSS) activity test (EPA Protocol #01-1A). In yet another embodiment, the composition provides full kill of gram negative bacteria according to the Association of Official Analytical Collaboration (AOAC) Use Dilution Test (UDT) for Testing Disinfectants (MB-05-16).

While specific embodiments are discussed, the specification is illustrative only and not restrictive. Many variations of this disclosure will become apparent to those skilled in the art upon review of this specification.

Unless defined otherwise, all technical and scientific terms used herein have the same meaning as is commonly understood by one of skill in the art to which this specification pertains.

As used in the specification and claims, the singular form “a”, “an” and “the” includes plural references unless the context clearly dictates otherwise.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

The present disclosure will further be described by reference to the following examples. The following examples are merely illustrative and are not intended to be limiting.

### Example 1—Stabilizing Varying Concentration of Ethanol in the Composition

Compositions containing increasing amounts of ethanol were prepared based on the composition shown in Formulation A. The pH of Formulations A, B, C, and D were maintained “as-is”, between pH 4-5.

TABLE 1
“Low pH” Compositions

| Components | A | B | C | D | E | F |
|---|---|---|---|---|---|---|
| (actives) | (wt. %) | (wt. %) | (wt. %) | (wt. %) | (wt. %) | (wt. %) |
| Quaternary ammonium | 0.25 | 0.25 | 0.25 | 0.25 | 0.25 | 0.25 |
| compound (1)¹ | | | | | | |
| Quaternary ammonium | 0.25 | 0.25 | 0.25 | 0.25 | 0.25 | 0.25 |
| compound (2)² | | | | | | |
| Synthetic polymer (1) | 0.25 | 0.25 | 0.25 | 0.25 | 0.25 | 0.25 |
| Amine oxide surfactant | 0.0675 | 0.0675 | 0.0675 | 0.0675 | 0.0675 | 0.0675 |
| (1) | | | | | | |
| Amine oxide surfactant | 0.155 | 0.155 | 0.155 | 0.155 | 0.155 | 0.155 |
| (2) | | | | | | |
| Organic acid (1) | 0.18 | 0.18 | 0.18 | 0.18 | 0.18 | 0.18 |
| Organic acid (2) | 0.0675 | 0.0675 | 0.0675 | 0.0675 | 0.0675 | 0.0675 |
| Strong base (1) | — | — | — | — | | |
| Ethanol | — | 10 | 20 | 30 | 35 | 50 |
| Water | Complete to 100% | | | | | |
| Formulation pH | 4-5 | 4-5 | 4-5 | 4-5 | 4-5 | 4-5 |
| Appearance | Clear | Clear | Clear | Clear | Slight | Turbid |
| | | | | | haze | |

¹Quaternary ammonium compound (1) is alkyldimethylbenzylammonium chloride (ADBAC); and
²Quaternary ammonium compound (2) is didecyldimethylammonium chloride (DDAC).

Compositions at low pH (e.g. 4-5) could tolerate up to about 30% wt. ethanol, while still maintaining a clear and homogenous appearance. That is, no phase instability was observed visually. Upon further addition of ethanol, haziness/turbidity is observed in the solution. This is indicative of phase instability and/or incompatibility of the ethanol in the system, and was observed to occur around 35% wt. ethanol (Formulation E) and above. Formulation F, containing 50% wt. ethanol, showed obvious turbidity. Intermediate levels of ethanol (40%, 45%) were also tested, and showed turbidity also.

TABLE 2
“Elevated pH” Compositions

| Components | G | H | I | J | K |
|---|---|---|---|---|---|
| (actives) | (wt. %) | (wt. %) | (wt. %) | (wt. %) | (wt. %) |
| Quaternary | 0.25 | 0.25 | 0.25 | 0.05 | 0.05 |
| ammonium | | | | | |
| compound (1)¹ | | | | | |
| Quaternary | 0.25 | 0.25 | 0.25 | 0.05 | 0.05 |
| ammonium | | | | | |
| compound (2)² | | | | | |
| Synthetic polymer (1) | 0.25 | 0.25 | 0.25 | 0.05 | 0.05 |
| Amine oxide | 0.0675 | 0.0675 | 0.0675 | 0.0135 | 0.0135 |
| surfactant (1) | | | | | |
| Amine oxide | 0.155 | 0.155 | 0.155 | 0.031 | 0.031 |
| surfactant (2) | | | | | |
| Organic acid (1) | 0.18 | 0.18 | 0.18 | 0.036 | 0.036 |
| Organic acid (2) | 0.0675 | 0.0675 | 0.0675 | 0.0135 | 0.0135 |
| Strong base (1) | 0.06 | 0.122 | 0.122 | 0.022 | 0.023 |
| Ethanol | — | 30 | 50 | 30 | 50 |
| Water | Complete to 100% | | | | |
| Formulation pH | 7-8 | 7-8 | 7-8 | 7-8 | 7-8 |
| Appearance | Turbid | Slight | Clear | Slight | Clear |
| | | haze | | haze | |

¹Quaternary ammonium compound (1) is alkyldimethylbenzylammonium chloride (ADBAC); and
²Quaternary ammonium compound (2) is didecyldimethylammonium chloride (DDAC).

The base composition, Formulation A, when adjusted to a pH of 7-8, as indicated in Formula G, shows turbidity and therefore is considered to have phase instability. However, increasing the ethanol content for the same compositions at pH 7-8 (Formulations H & I) incrementally improves the phase stability, and a clear and homogenous appearance can be obtained. That is, formulations with elevated pH can be achieved by way of incorporating more polar solvent, in this case ethanol.

### Example 2—Evaluation of Film Residual Biocidal Activity (RSS-Screening)

Compositions from Example 1 were selected for assessment of residual biocidal efficacy according to the RSS-Screening test described herein. Also included in the experiment was a commercial benchmark, containing >50-60% wt. ethanol and approximately 0.1% total wt. of quaternary ammonium compound(s). This commercial benchmark does not have a 24-hr residual efficacy claim as substantiated by the EPA RSS Protocol #01-1A. 100 microliters of each composition was pipetted onto a stainless steel substrate and allowed to dry as indicated in EPA Protocol #01-1A. The films were then subjected to at least 6 wear cycles (all “wet”, none “dry”), without reinoculation between wear cycles, in a manner consistent with the RSS test. The RSS-Screening test was carried out against Pseudomonas aeruginosa with a 5 minute contact time under dirty (soiled) conditions

TABLE 3
RSS-Screening Results (P. aeruginosa), 5 minute contact time)

| Composition Tested | Result |
|---|---|
| (Formulation) | (Log Reduction) |
| H | Pass (>3 log reduction) |
| I | Pass (>3 log reduction) |
| J | Pass (>3 log reduction) |
| K | Pass (>3 log reduction) |
| Commercial Benchmark | Fail (<3 log reduction) |

Formulations H, I, J, and K all passed the RSS-Screening test, demonstrating that the films obtained from these compositions, after application and drying on a hard surface, provide long lasting antimicrobial efficacy. This indicates that incorporating and stabilizing the ethanol, at concentrations up to 50% wt., does not negatively disrupt the film integrity or film formation needed for long lasting antimicrobial efficacy. Furthermore, the lack of residual efficacy from the commercial benchmark, which contains similar amounts of ethanol and total quaternary ammonium compound(s), demonstrates that not only do the instant compositions demonstrate long lasting antimicrobial efficacy, but demonstrate unexpectedly better phase stability and lack of turbidity. It should also be noted that Formulation A passes both the EPA RSS Protocol #01-1A and RSD test when evaluated against P. aeruginosa with a contact time of 5 minutes under dirty conditions. It is contemplated that, based on the similarities between the RSS-Screening and EPA RSS Protocol #01-1A tests described herein, that the formulations similar to those in Table 3 would also pass according to Protocol #01-1A. It is further contemplated that the same formulations would pass the EPA RSD test, also described herein.

### Example 3—Evaluation of Disinfecting Efficacy (“Quick-kill) AOAC UDT Testing

Compositions outlines in Example 1 were further tested for “quick-kill” disinfectant efficacy according to the Association of Official Analytical Collaboration (AOAC) Use Dilution Test (UDT) for Testing Disinfectants (MB-05-16). The test organism was Staphylococcus aureus under dirty conditions. These experiments were both a 3 minutes and 1 minute contact time.

TABLE 4
AOAC UDT MB-05-16 Testing (S. aureus, Dirty Conditions)Description Table

| Composition Tested | Result - 3 minute Contact Time | Result - 1 minute Contact Time |
|---|---|---|
| (Formulation) | (# Failing Cells out of 20) | (# Failing Cells out of 20) |
| A | Pass (0 failing cells) | Fail (3 failing cells) |
| I | Pass (0 failing cells) | Pass (0 failing cells) |

Both Formulation A and I pass against AOAC UDT MB-05-16 with a 3 minute contact time against Staphylococcus aureus under dirty conditions. However, when decreasing the contact time to 1 minute, only Formulation I passes. This result indicates that stabilizing ethanol in the core composition at an elevated pH provides improved “quick-kill” disinfecting efficacy as demonstrated by AOAC UDT MB-05-16 in addition to also demonstrating long lasting antimicrobial efficacy, as demonstrated above in Table 3. Simply put, compositions of the present invention with high amounts of stabilized ethanol demonstrate not only improved “quick-kill” disinfection efficacy, but also have long lasting antimicrobial efficacy and better phase stability, with a lack of turbidity. It is contemplated that compositions similar to Formulation I could achieve even quicker kill times, such as 45 seconds, 30 seconds, or even 10 seconds according to AOAC UDT MB-05-16.

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

What is claimed is:

1. A hard surface treatment composition comprising:
a. an antimicrobial component comprising at least one quaternary ammonium compound;
b. a synthetic polymer comprising:
i. at least one cationic monomer A_{b},
ii. optionally, at least one anionic monomer Bₐ, and
iii. optionally, at least one non-ionic monomer Cₐ;
c. an organic acid;
d. at least 20 wt. % of an organic polar solvent, preferably at least 30 wt. % of an organic polar solvent, based on a total weight of the composition; and
e. a surfactant selected from the group consisting of cationic surfactants, amphoteric surfactants and combinations thereof,
wherein the composition is free of non-ionic surfactants and the composition has a pH of at least 7.

2. The composition of claim 1, wherein a film formed from the composition kills at least 95% of microorganisms for at least 3 wet abrasion cycles and at least 3 dry abrasion cycles, with 2 abrasions per cycle according to RSS-12 h.

3. The composition of claim 1, wherein a film formed from the composition kills at least 95% of microorganisms for at least 6 wet abrasion cycles and at least 6 dry abrasion cycles, with 2 abrasions per cycle according to RSS.

4. The composition of claim 1, wherein a film formed from the composition kills at least 95% of microorganisms for at least 6 wet abrasion cycles and at least 6 dry abrasion cycles, with 4 abrasions per cycle according to RSD.

5. The composition of claim 1, wherein the antimicrobial component is selected from the group consisting of monoalkyldimethylbenzyl ammonium salts, dialkyldimethyl ammonium salts, and combinations thereof.

6. The composition of claim 1, wherein the monomer A_{b} is selected from the group consisting of diallyldimethylammonium halides.

7. The composition of claim 1, wherein the polymer comprises monomer Bₐ selected from the group consisting of acrylic acid, methacrylic acid, and combinations thereof.

8. The composition of claim 1, wherein the polymer comprises monomer Cₐ selected from the group consisting of 2-(dimethylamino)ethyl methacrylate (DMAEMA); N-vinyl pyrrolidone (NVP); N-vinylimidazole; acrylamide; methacrylamide; and combinations thereof.

9. The composition of claim 1, wherein the organic acid is selected from the group consisting of citric, malic, maleic, lactic, succinic, glutaric, adipic acids and combinations thereof.

10. The composition of claim 1, wherein the surfactant comprises a cationic surfactant selected from the group consisting of cationic amine oxides.

11. The composition of claim 1, wherein the surfactant comprises an amphoteric surfactant selected from the group consisting of sultaines, taurates, and combinations thereof.

12. The composition of claim 1 further comprising a polar solvent.

13. The composition of claim 1, wherein a film formed from the composition kills at least 95% of gram-positive bacteria and gram-negative bacteria, or enveloped and non-enveloped viruses according to Environmental Protection Agency (EPA) Protocol #01-1A residual self-sanitizing activity test.

14. The composition of claim 1 further comprising at least one base, preferably at least one hydroxide of an alkali metal, hydroxide of an alkaline earth metal, or combinations thereof.

15. A hard surface treatment concentrate composition comprising:
a. an antimicrobial component comprising at least one quaternary ammonium compound in an amount ranging from 800 ppm to about 100,000 ppm;
b. a synthetic polymer in an amount ranging from about 800 ppm to about 50,000 ppm comprising:
i. at least one cationic monomer A_{b},
ii. optionally, at least one anionic monomer Bₐ, and
iii. optionally, at least one non-ionic monomer Cₐ;
c. an organic acid in an amount ranging from about 1,000 ppm to about 35,000 ppm; and
d. a surfactant selected from the group consisting of cationic surfactants, amphoteric surfactants and combinations thereof in an amount ranging from about 2,000 ppm to about 90,000 ppm,
wherein the composition is free of non-ionic surfactants.

16. The composition of claim 15 further comprising at least one base, preferably at least one hydroxide of an alkali metal, hydroxide of an alkaline earth metal, or combinations thereof.

17. A method of providing a surface with residual antimicrobial action that comprises the step of applying the composition of claim 1 to the surface.

18. A substrate with residual antimicrobial action comprising a substrate wherein at least a portion of the substrate is coated with the composition of claim 1.

19. The composition of claim 1 comprising at least 20 wt. % to 65 wt. %, preferably at least 35 wt. % to 60 wt. %, of the organic polar solvent, based on a total weight of the composition.

20. The composition of claim 1, wherein the organic polar solvent is an aliphatic alcohol, preferably selected from C₂-C₆ aliphatic alcohols.

21. The composition of claim 1, wherein the organic polar solvent is selected from ethyl alcohol, propyl alcohol, including isopropyl alcohol, butyl alcohol, and mixtures thereof.

22. A method of stabilizing an organic polar solvent in a hard surface treatment composition, the hard surface treatment composition comprising:
a. an antimicrobial component comprising at least one quaternary ammonium compound;
b. a synthetic polymer comprising:
i. at least one cationic monomer Ab,
ii. optionally, at least one anionic monomer Ba, and
iii. optionally, at least one non-ionic monomer Ca;
c. an organic acid;
d. at least 20 wt. % of an organic polar solvent, preferably at least 30 wt. % of an organic polar solvent, based on a total weight of the composition;
e. a surfactant selected from the group consisting of cationic surfactants, amphoteric surfactants and combinations thereof; and
f. at least one base, preferably at least one hydroxide of an alkali metal, hydroxide of an alkaline earth metal, or combinations thereof,
wherein the composition is free of non-ionic surfactants, and wherein the method comprises adding the at least one base to the hard surface treatment composition to adjust the pH of the hard surface treatment composition to at least 7, and preferably to a pH of about 7 to 10.

23. The method of claim 20, wherein the base is selected from sodium hydroxide, potassium hydroxide, lithium hydroxide, magnesium hydroxide, calcium hydroxide, ammonia, ammonium hydroxide, and mixtures thereof.
